(19) United States
(12) Patent Application Publication
(10) Pub. No.: US 2013/0235571 A1
(43) Pub. Date: Sep. 12, 2013

(54) RECESSED MULTICOLORED LED LAMP

(71) Applicant: Vahram Boyajyan, Glendale, CA (US)

(72) Inventor: Vahram Boyajyan, Glendale, CA (US)

(21) Appl. No.: 13/416,225

(22) Filed: Mar. 9, 2012

(51) Int. Cl. F21V 9/00

(52) U.S. Cl. 362/231

(57) ABSTRACT

A lightning system includes a back housing which encloses a LED controller. A heat sink is coupled to the back housing. A main LED array is coupled to the heat sink, where the main LED array is electrically coupled to the LED controller. A secondary LED array is coupled to the heat sink, where the secondary LED array is electrically coupled to the LED controller and comprises RGB LEDs capable of selectively emitting different colored light. The lightning system includes a front panel which includes an inner central panel and an outer surrounding panel. The inner central panel is coupled to the heat sink and at least partially permits light emitted from the main LED array to pass through. The outer surrounding panel is coupled to the heat sink, circumscribes the inner central panel, and at least partially permits light emitted from the secondary LED array to pass through.

### BACKGROUND OF THE INVENTION

1. Field of the Invention

The present invention relates to the field of lighting and more particularly but not by way of limitation relates to multicolored LED lamps for insertion into recessed structures.

2. Description of the Related Art

Light-emitting diode (LED) lighting is gaining popularity as an environmentally friendly and efficient lighting solution. LED lamps have many advantages over other forms of lighting. LED lamps have higher efficiency than incandescent bulbs. A conventional incandescent light bulb of 60 to 100 watts emits around 15 lumens per watt. By contrast, a typical commercial LEDs designed to replace incandescent light bulbs emit from 17 to 79 lumens per watt. As a result of the higher light-producing efficiency of LEDs lamps, less heat is produced as an unwanted byproduct.

LED lamps often have much longer service lifetimes than incandescent lights. LEDs typically have a life expectancy of over 50,000 hours in comparison to the 750 hours for incandescent lights.

LED lamps may turn on from an off state and achieve full brightness in under a microsecond unlike florescent lamps which achieve full brightness much slower. In addition, florescent lamps fail faster than LED lamps when cycled on and off often.

LED lamps also avoid the hazardous chemicals found in some other lighting options. Compact florescent lamps contain mercury which seeps into the Earth's soil and water supply if not specially discarded. LED lamps do not contain mercury and can be safely discarded normally.

U.S. Pat. No. 7,959,332 B2 and U.S. Pat. No. 7,677,770 B2 both disclose recessed LED fixtures that take advantage of the increased efficiency of LEDs over incandescent lamps and the environmental friendliness of LEDs over compact florescent lamps. However, both recessed LED fixtures each have only one LED array which emits only a single color of light. These fixtures do not satisfy the needs of business, residential, and educational facilities that require a recessed LED lamp capable of simultaneously emitting different colored lights.

As such, there is a need in the art for a recessed LED lamp with two LED arrays capable of simultaneously emitting different colored lights.

### BRIEF SUMMARY OF THE INVENTION

Embodiments of the invention described herein are directed to a lighting system. In one embodiment of the invention, the lightning system includes a back housing which encloses a LED controller. A heat sink is coupled to the back housing. A main LED array is coupled to the heat sink, where the main LED array is electrically coupled to the LED controller. A secondary LED array is coupled to the heat sink, where the secondary LED array is electrically coupled to the LED controller and comprises RGB LEDs capable of selectively emitting different colored light. The lightning system includes a front panel which includes an inner central panel and an outer surrounding panel. The inner central panel is coupled to the heat sink and at least partially permits light emitted from the main LED array to pass through. The outer surrounding panel is coupled to the heat sink, circumscribes the inner central panel, and at least partially permits light emitted from the secondary LED array to pass through.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a LED lamp in accordance with an embodiment of the present invention;

FIG. 2 illustrates a bottom view of a LED lamp 100 in accordance with an embodiment of the present invention;

FIG. 3 illustrates electrical couplings of a LED lamp 100 in accordance with an embodiment of the present invention;

FIG. 4 illustrates a wireless remote controller 400 of a lighting system in accordance with an embodiment of the present invention.

### DETAILED DESCRIPTION

A light-emitting diode (LED) lighting system will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the true scope of the invention.

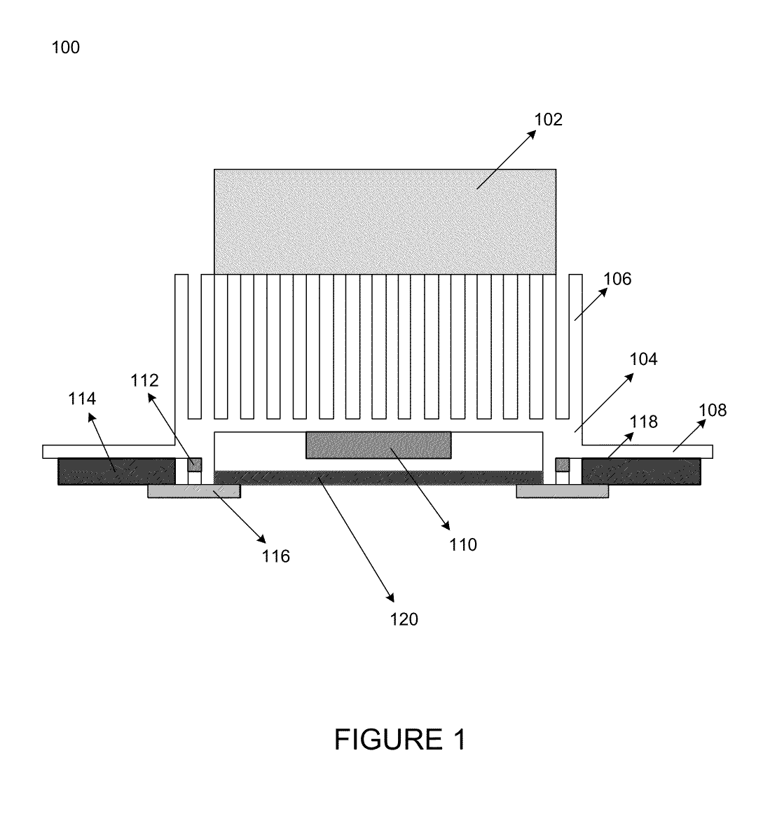

FIG. 1 illustrates a side view of an exemplary LED lamp 100 in accordance with an embodiment of the present invention. A cylindrical shaped back housing 102 may be formed from plastic polymers or a combination of suitable materials such as fiberglass, ceramics, and metals.

In some embodiments, a top surface of a heat sink 104 is coupled to a bottom surface of the back housing 102. The heat sink 104 is typically at least partially formed from materials with high thermal conductivity such aluminum or copper. Excessive heat in the LED lamp 100 may lead to loss in light producing efficiency and shortened lifespan. The heat sink 104 serves the purpose of dissipating heat away from the LED lamp 100 to the surrounding air. In some embodiments, the heat sink 104 may have a cylindrical shaped body 106 with fins radially extending from the center axis of the cylindrical shaped body 106 as is common in the art. The fins may extend from the top surface of the cylindrical shaped body 106 to a bottom surface of the cylindrical shaped body 106. In addition, the heat sink 104 may have a washer shaped base 108 coupled to the bottom portion of the cylindrical shaped body 106.

A main LED array 110 is coupled to the heat sink. In some embodiments, the main LED array 100 is disc shaped and is coupled to the bottom surface of the cylindrical shaped body of the heat sink. A typical LED array comprises a plurality of LEDs mounted to a circuit board substrate. Each LED comprises a semiconductor material added with impurities to create a positive-negative (p-n) junction. When current flows between the positive and negative junctions, energy is emitted from the LED in the form of light. The color or wavelength of the light emitted is partially based on semiconductor materials used. LED color also changes with small variations in driving current. Most LEDs, regardless of type, color, size, or power, work best when driven with a constant current. The main LED may be configured to emit white light or configured to emit light of any color. A white light may be emitted by coating a blue colored LED with phosphor. A white light may also be emitted by combing red, green, and blue colored LEDs, together known as RGB LEDs. For example, Red light of wavelength between 610 nm and 760 nm may be produced from aluminum gallium arsenide (ALGaAs) or gallium arsenide phosphide (GaAsP). Green light of wavelength between 500 nm and 570 nm may be produced from indium gallium nitride (InGaN) or aluminum gallium phosphide (ALGaP). Blue light of wavelength between 450 nm and 500 nm may be produced from zinc selenide (ZnSe) or indium gallium nitride (InGaN). Red, green, and blue light of various intensities emitted from RGB LEDs may be superimposed to produce a variety of colored light.

A secondary LED array 112 is coupled to the heat sink, where the secondary LED array 112 includes RGB LEDs capable of selectively emitting different colored light. In some embodiments, the secondary LED array 112 is coupled to a bottom surface of the washer shaped base 108 of the heat sink 104.

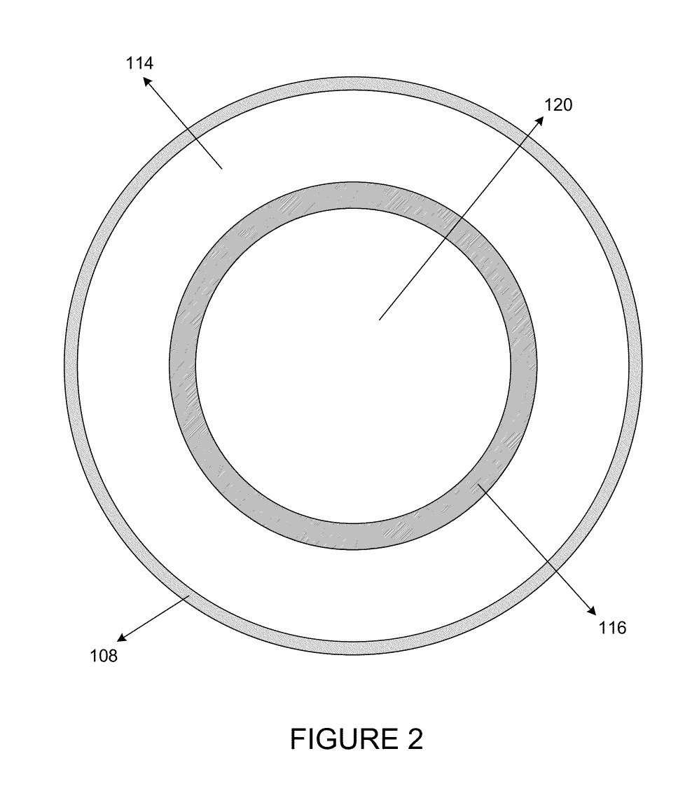

FIG. 2 illustrates a bottom view of a LED lamp 100 in accordance with an embodiment of the present invention. The LED lamp 100 comprises a front panel which includes an inner central panel 120 and an outer surrounding panel 114. In some embodiments, the front panel is disc shaped and includes a trim ring 116 coupled to the inner central panel 120 and the outer surrounding panel 114. The outer surrounding panel 114 circumscribes the inner central panel 120. The inner central panel 120 may be disc shaped and coupled to the bottom surface of the cylindrical shaped body 106 of the heat sink 104. The outer surrounding panel 114 may be washer shaped and coupled to the bottom surface of the washer shaped base 108 of the heat sink 104. A reflective surface may span substantially the bottom surface of the heat sink which functions to reflect the emitted light away from the LED lamp 100. The inner central panel 120 at least partially permits light emitted from the main LED array 110 to pass through. The inner central panel 120 functions to produce a desired light distribution from the light emitted from the main LED array 110. The outer surrounding panel 114 at least partially permits light emitted from the secondary LED array 112 to pass through. The outer surrounding panel functions to produce a desired light distribution from the light emitted from the secondary LED array 112. In some embodiments, the inner central panel 120 or the outer surrounding panel 114 is made of a translucent material such as frosted glass or frosted transparent thermoplastic.

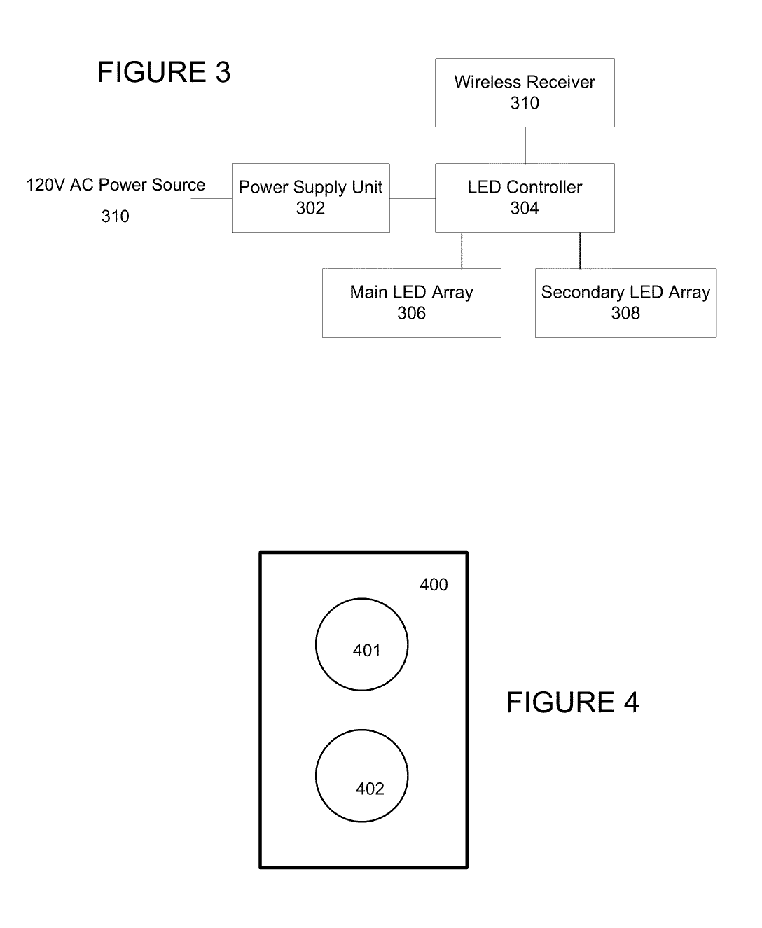

FIG. 3 illustrates electrical couplings of a LED lamp 100 in accordance with an embodiment of the present invention. In some embodiments, the back housing 102 includes a power supply unit 302. The power supply 302 is electrically coupled to a LED controller 304 and an alternating current power source 310. The power supply unit 302 functions to provide constant direct current to the LED controller 304. The LED controller 304 is electrically connected to the main LED array 110 and the secondary LED array 112. The LED controller 304 may selectively turn the main LED array 110 and secondary LED array 112 on or off. Additionally, the LED controller 304 determines the light colors emitted from the main LED array 110 and secondary LED array 112.

FIG. 4 illustrates a wireless remote controller 400 of a lighting system in accordance with an embodiment of the present invention. In some embodiments, the back housing 102 contains the wireless receiver 310 which is coupled to the power supply unit 302 and the LED controller 304. The wireless receiver 310 receives wireless command signals from a wireless remote controller 400. The wireless remote controller 400 contains a transmitter for transmitting command signals to the wireless receiver 310. The wireless remote controller may include buttons 401-2, which when selectively pressed, may turn on or off and change emitted light colors of the main LED array 110 and secondary LED array 112. The wireless remote controller 400 may include a first button 401, which when pressed will cycle the main LED array 110 between emitting white light and turning off. The wireless remote controller 400 may include a second button 402, which when pressed will cycle the secondary LED array 112 between emitting various colors of light and turning off.

Mounting hangers may be coupled to the heat sink 104 or to the back housing 102 to facilitate mounting the LED lamp 100 to a ceiling, floor, or wall recess. Such mounting hangers for recessed lamps are varied and well known in the art.

What is claimed is:

1. A lightning system comprising:
a back housing;
a heat sink coupled to said back housing;
a main LED array coupled to said heat sink;
a secondary LED array coupled to said heat sink, wherein said secondary LED array comprises RGB LEDs capable of selectively emitting different colored light; and
a front panel, wherein said front panel comprises
an disc shaped inner central panel coupled to said heat sink, wherein said inner central panel at least partially permits light emitted from said main LED array to pass through, and
an outer surrounding panel coupled to said heat sink, wherein said outer surrounding panel at least partially permits light emitted from said secondary LED array to pass through.

2. The system of claim 1, wherein said main LED array comprises RGB LEDs capable of selectively emitting a variety of colored light.

3. The system of claim 1, wherein said heat sink has a cylindrical shaped body and a washer shaped base,
wherein said cylindrical shaped body has fins radially extending from a center axis of said cylindrical shaped body and extending from a top surface of said cylindrical shaped body to a bottom surface of said cylindrical shaped body, and
wherein said washer shaped base is coupled to said bottom surface of said cylindrical shaped body.

4. The system of claim 1, wherein said front panel comprises a trim ring coupled to said inner central panel and said outer surrounding panel.

5. The system of claim 1, wherein said inner central panel comprises a translucent material.

6. The system of claim 1, wherein said outer surrounding panel comprises a translucent material.

7. The system of claim 1, wherein said back housing comprises a LED controller and a wireless receiver, wherein said LED controller is electrically coupled to said wireless receiver, said main LED array, and said secondary LED array.

8. The system of claim 7, additionally comprising a wireless remote controller which functions to turn on or off and to change emitted light colors of said main LED array and said secondary LED array.

9. The system of claim 1, additionally comprising a reflective surface, wherein said reflective surface spans substantially a bottom surface of the heat sink.

10. The system of claim 1, additionally comprising one or more mounting hangers.

11. A recessed multicolored LED lamp comprising:
a cylindrically shaped back housing, wherein said back housing encloses a LED controller;
a heat sink coupled to said back housing;
a main LED array coupled to said heat sink, wherein said main LED array is electrically coupled to said LED controller;
a secondary LED array coupled to said heat sink, wherein said secondary LED array is electrically coupled to said LED controller and comprises RGB LEDs capable of selectively emitting different colored light; and
a front panel, wherein said front panel comprises
an inner central panel coupled to said heat sink, wherein said inner central panel at least partially permits light emitted from said main LED array to pass through, and
an outer surrounding panel coupled to said heat sink, wherein said outer surrounding panel circumscribes said inner central panel and at least partially permits light emitted from said secondary LED array to pass through.

12. A recessed multicolored LED lamp comprising:
a cylindrically shaped back housing, wherein said back housing encloses a LED controller;
a heat sink coupled to said back housing, wherein said heat sink comprises a cylindrical shaped body and a washer shaped base coupled to said cylindrical shaped body;
a main LED array coupled to said heat sink, wherein said main LED array is electrically coupled to said LED controller;
a secondary LED array coupled to said heat sink, wherein said secondary LED array is electrically coupled to said LED controller and comprises RGB LEDs capable of selectively emitting different colored light; and
a front panel, wherein said front panel comprises
a disc shaped inner central panel coupled to said heat sink, wherein said inner central panel at least partially permits light emitted from said main LED array to pass through, and
a washer shaped outer surrounding panel coupled to said heat sink, wherein said outer surrounding panel circumscribes said inner central panel and at least partially permits light emitted from said secondary LED array to pass through.
